(19) United States
(12) Patent Application Publication
(10) Pub. No.: US 2006/0047954 A1
(43) Pub. Date: Mar. 2, 2006

(54) Data access security implementation using the public key mechanism

(75) Inventors: Kapil Sachdeva, Austin, TX (US); Sylvain Prevost, Austin, TX (US)

Correspondence Address: ANDERSON & JANSSON L.L.P., 9501 N. CAPITAL OF TX HWY #202, AUSTIN, TX, 78759, US

(73) Assignee: Axalto Inc., Austin, TX (US)

(21) Appl. No.: 10/929,208

(22) Filed: Aug. 30, 2004

(51) Int. Cl. H04L 9/00

(52) U.S. Cl. 713/165

(57) ABSTRACT

Providing application programs the right to access a data item while preventing security breaches, allowing applications and data to be independently updated, and allowing multiple applications to share the data item. Each application program has associated therewith a first public key and each data file has associated therewith a second public key. If these public keys match for a particular application program and data file, the application program is granted access to the data file.

### BACKGROUND OF THE INVENTION

1. Field of the Invention

The present invention relates generally to data access control for computer programs during run-time and more particularly to access control using a public key mechanism.

2. Description of the Related Art

Smart cards are small personal computing devices that are used to protect very sensitive information. Smart cards may be used to perform banking functions, provide access to health records, personalization of computer network access, secure building access, and many more functions. Smart cards are also used as subscriber identity modules (SIM) in certain mobile telephony networks.

A crucial selling point of smart cards is the security of the data stored thereon or accessed through the use of smart cards. In many circumstances smart cards provide heightened levels of security than other security mechanisms because smart cards include a combination of security features. For example, to gain access to some data you need to know a password stored on the smart card and you must be in possession of the smart card.

A recent trend in smart card technology is so called multi-application smart cards. These cards may be programmed with multiple disjointed application programs. For example, the same card may be used to access both banking records as well as provide health care information. Examples of such cards include the Cyberflex family of cards from Axalto Inc.

A common feature of multi-application smart cards is that the application programs may be loaded onto the smart card after the card has been issued by the manufacturer or even after an end-user has taken possession of the card. Each such application program in a multi-application smart card is stored in some form of programmable memory on the smart card.

Such post-manufacture programmability of smart cards provide increased flexibility and power of use of the smart cards. However, the price for that flexibility and power is vulnerability to attempts to unauthorized access of data. Because the application programs may be loaded onto a multi-application smart card after its manufacture, it is quite possible to load onto the smart card programs that attempt to perform functionality that attempt to breach the security of other applications already loaded onto the smart card.

One such risk is that one application program attempts to access private data of another application program on the same smart card.

The risks of such unauthorized are numerous. It is conceivable that a program that otherwise appears to behave as expected, issues unauthorized transactions or reveals private information to unauthorized persons.

Hitherto, un-authorized access of smart card application program data by unauthorized programs have been avoided by logically linking data used by an application program to that application program and preventing one such unit from accessing another by erecting firewalls between application programs. Protecting data of one application program from access from another application program using a firewall mechanism also preclude desirable sharing of data files between programs. Furthermore, close linking of application programs and data files frustrate independent updates of an application program and the data that the application program uses.

Often it is useful to update a program without updating the data that is associated with the program. For example, very often application programs have a preference file associated with the application program in which the user's personal preferences and other information is stored. When manufacturers issue new updates to their application programs, it is preferable to not override these preference files.

There has been a need to perform verification that an application program trying to access a piece of data of another program has sufficient rights to do so. It is desirable that such checking occurs during run-time. Accordingly, from the foregoing it is apparent that there is a still an unresolved need for a system and methodology for verifying authorization of smart card application programs attempting access to application data of other application programs during run-time. It is desirable that any such system and methodology allows the application programs and data files associated with the application programs to be updated independently of one another and still allow an updated application program access to data associated therewith, and vice versa.

### SUMMARY OF THE INVENTION

In a preferred embodiment, a system and method according to the invention guard against unauthorized access to the data of one application program by another application program while not preventing authorized cross-application data access or independent updated of application programs and data associated therewith. On a programmable multi-application smart-card, or other programmable computer system, a file-system contains a first application program having associated therewith a first public key and a data file having associated therewith a second public key, wherein the first application program contains data access logic operable to cause the microprocessor of the smart card or computer system to attempt to access the data file. The smart card also contains an interpreter or other operating system for controlling the execution of application programs on the smart card or other computer system. The interpreter has an authorization logic with instructions operable to cause the microprocessor to compare the public key associated with the first application program and permitting access if the public key associated with the first application program corresponds to public key associated with the data file, and otherwise rejecting access.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a schematic illustration of the operating environment in which a smart card according to the invention may be used to provide secure computing services.

FIG. 2 is a schematic illustration of an exemplary architecture of a resource-constrained device.

FIG. 3 is a schematic illustration of a software architecture for a resource-constrained device.

FIG. 4(a) is a timing flow diagram illustrating the operation of a method or system according to the invention to create a new data item and establishing a mechanism based on Public Key s to ensure that application programs that seek access to the data item has sufficient access rights to allow the application program access to data item.

FIG. 4(b) is a timing flow diagram illustrating the operation of a method or system according to the invention to verify during the run-time of the application program that the application program has sufficient access rights to allow the application program access to a particular piece of data the application program seeks to access.

FIG. 5 is a screen shot used to illustrate the operation of the system of method of the invention, in particular illustrating the Public Key of a first application program.

FIG. 6 is a code segment of the application program of FIG. 5 illustrating that the first application program seeks access to a particular data item.

FIG. 7 is a screen shot used to illustrate the operation of the system of method of the invention, in particular illustrating the Public Key of a the data item that the application program code of FIG. 6 seeks to access.

FIG. 8 is a screen shot used to illustrate the operation of the system of method of the invention, in particular illustrating the Public Key of a second application program.

FIG. 9 is a code segment of the second application program of FIG. 8 illustrating that the second application program seeks access to a particular data item, namely the data item illustrated in FIG. 6.

FIG. 10 is a screen shot used to illustrate the operation of the system of method of the invention, in particular illustrating the issuance of an error condition to indicate that the second application program does not have sufficient access rights to access the data item of FIG. 6.

### DETAILED DESCRIPTION OF THE INVENTION

In the following detailed description and in the several figures of the drawings, like elements are identified with like reference numerals.

As shown in the drawings for purposes of illustration, the invention is embodied in a system and method for guarding data items stored on a multi-application smart card from unauthorized access by application programs executing on the smart card. The system and method according to the invention uses the computer programming concept of Public Key of a public key infrastructure to grant or deny computer programs access to particular data items during execution. Public keys are described in Richard E. Smith, Authentication: From Passwords to Public Keys, Addison-Wesley, 2001, ISBN: 0201615991.

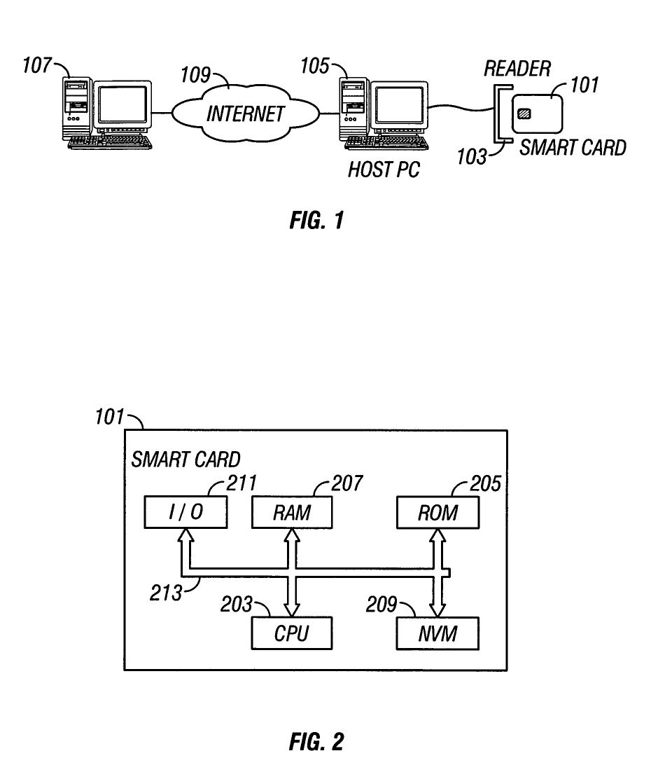

FIG. 1 is a schematic illustration of the operating environment in which a resource-constrained device according to the invention may be used to provide secure communication with a remote entity. A resource-constrained device 101, for example, a smart card, is connected to a computer network 109, for example, the Internet. The resource-constrained device 101 may be connected to the computer network 109 via a personal computer 105 that has attached thereto a card reader 103 for accepting a smart card. However, the resource-constrained device 101 may be connected in a myriad of other ways to the computer network 104, for example, via wireless communication networks, smart card hubs, or directly to the computer network 109. The remote node 105 is a computer system of some sort capable to implement some functionality that may either seek access to information on the smart card 101 or to which the smart card user may seek access. For example, the remote node 107 may be executing a banking software that a user of the smart card 101 is seeking to obtain access to. The smart card 101 may then provide some access control functionality or may even be an electronic purse to which funds are downloaded from the remote computer.

The scenario of FIG. 1 is presented here merely for the purpose of providing an example and must not be taken to limit the scope of the invention whatsover. Only the imagination of designers limits the myriad of possible deployment scenarios and uses for smart cards.

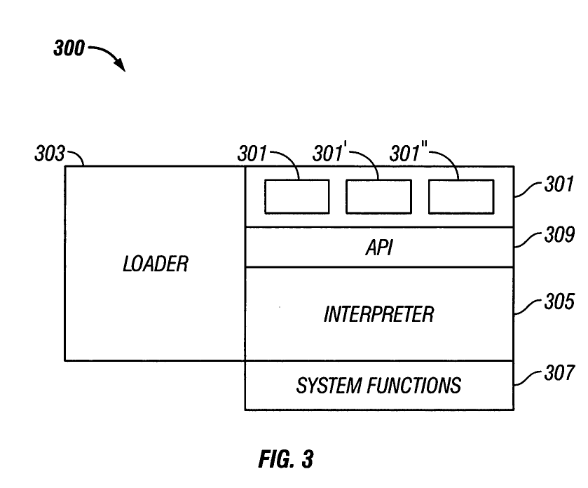

FIG. 2 is a schematic illustration of an exemplary architecture of a resource-constrained device 101. The resource-constrained device 101, e.g., a smart card has a central processing unit 203, a read-only memory (ROM) 205, a random access memory (RAM) 207, a non-volatile memory (NVM) 209, and a communications interface 211 for receiving input and placing output to a device, e.g., the card reader 102, to which the resource-constrained device 101 is connected. These various components are connected to one another, for example, by bus 213. In one embodiment of the invention, the SSL/TLS module 103, as well as other software modules shown in FIG. 1, would be stored on the resource-constrained device 101 in the ROM 206. During operation, the CPU 203 operates according to instructions in the various software modules stored in the ROM 205.

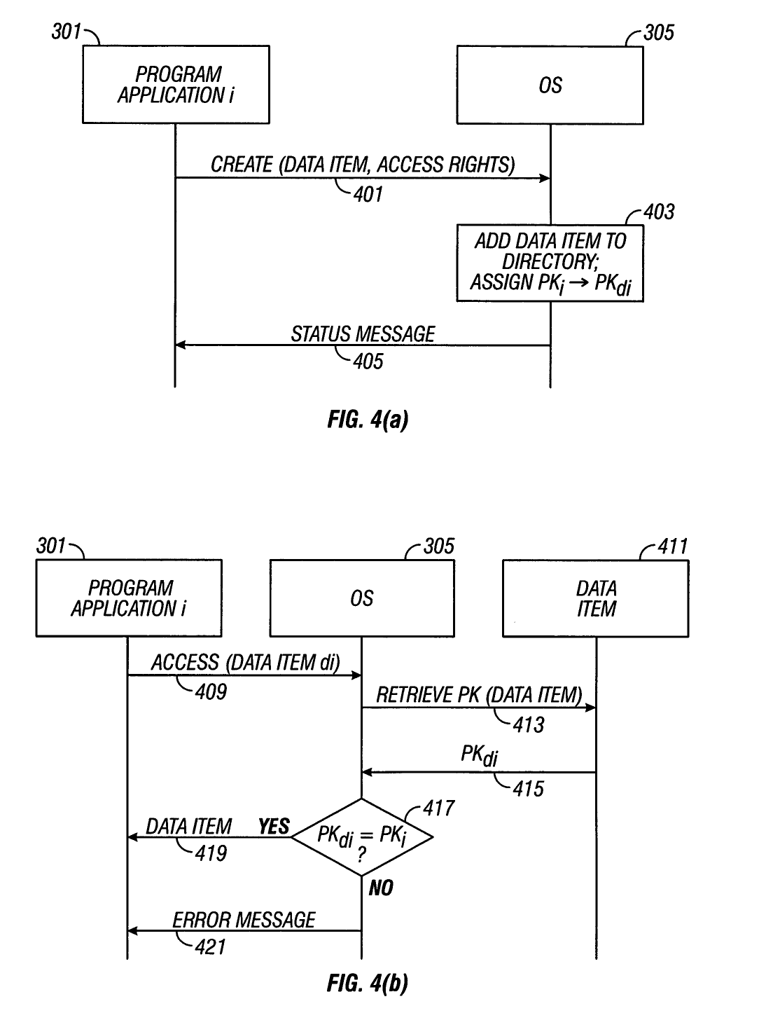

FIG. 3 is a block diagram of an exemplary software architecture 300 that one may find implemented on a smart card 101. The software architecture 300 includes several application programs 301, e.g., application programs 301, 301′, and 301″. These are loaded onto the smart card by a loader 303. The application programs 301 would typically be loaded into the non-volatile memory 209. However, in other scenarios an application program may be permanently written onto the smart card at manufacture by having it stored in the ROM 205. If the smart card 101 is called upon to execute a program for only one session, it would be possible to have the program loaded in the RAM 207. However, that would be a rare circumstance. On the other hand, during execution of an application program, it is indeed possible that certain portions of the application program are loaded into the RAM 207.

In this example, a several application programs 301 are executed by the CPU 203 under the control of instructions of an interpreter 305. The interpreter 303 may, for example, be a Javacard Virtual Machine as found on the Cyberflex smart card family from Axalto Inc. or the interpreter of a smart card implementing a .NET CLI (Common Language Infrastructure) as found in the .NET smart card technology from Axalto Inc. (www.axalto.com/infosec/NET_faq.asp). In alternative embodiments, the application programs 301 are compiled into executable code and do not require further interpretation by the interpreter 305. However, in such embodiments, the job control would be managed by some operating system program that would take the place of the interpreter 303.

The interpreter 303 is usually a static component of a smart card 101 and would therefore be loaded into the ROM 205. The interpreter 303 may also be burned into some form of firmware. In another alternative the interpreter 303 may be stored in the non-volatile memory 209.

In most embodiments of the invention, the smart card software architecture 300 also includes some system functions 307. System functions 307 may include security functionality, cryptography functionality, and utility libraries which may be called by application programs 301.

The application programs 301 may access functions provided by the smart card system software 307 by issuing calls through an application program interface 309.

One possible breach of security provided by a smart card 101 is that one of the application programs 301 accesses data items of another application programs without having adequate access rights. While in most cases an application program does not access data of another application program, in some circumstances it is desirable to permit certain access of a first application program to the data associated with a second application program. Such access to the data of another program allows application programs to share data or for one application program to be a producer of data that is consumed by another. Thus, it is desirable to provide a mechanism that can provide access and prevent access depending on what level of access a program should be allowed.

In a preferred embodiment of the present invention, public keys are used to provide access control for application programs attempting access to data items of other application programs. Applications loaded onto a smart card are cryptographically signed using the private key of the owner of the application. The signed application to be loaded contains the public-key blob, public key token and the signature. At the time of loading, the signature is verified. The signature verification process asserts the authenticity and integrity of application load file and the public key token embedded in it. This public key token can act as the unique identity or attribute of the data file, which also identifies the owner.

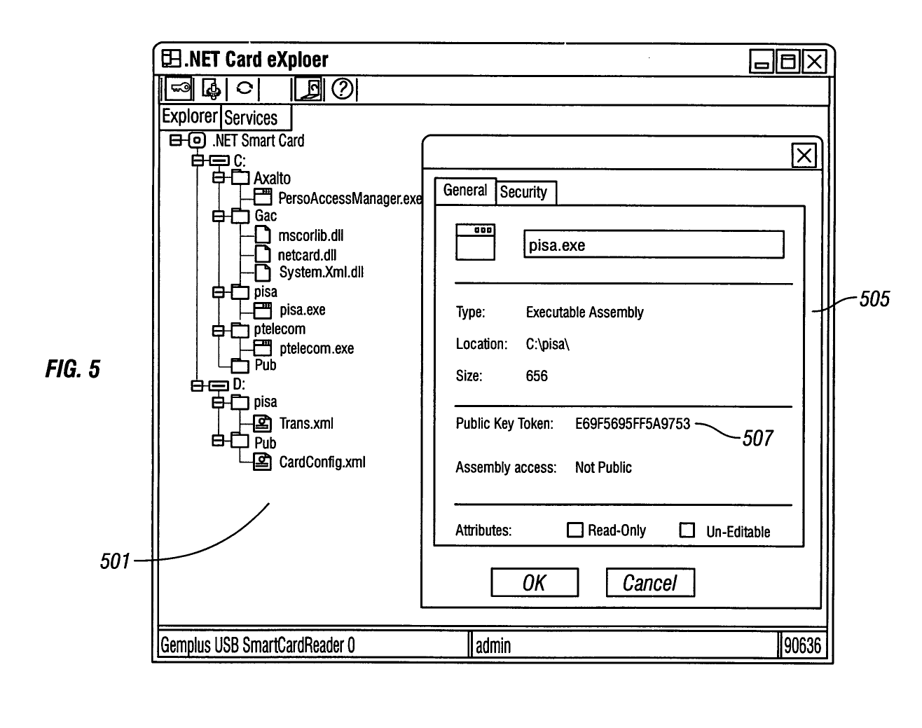

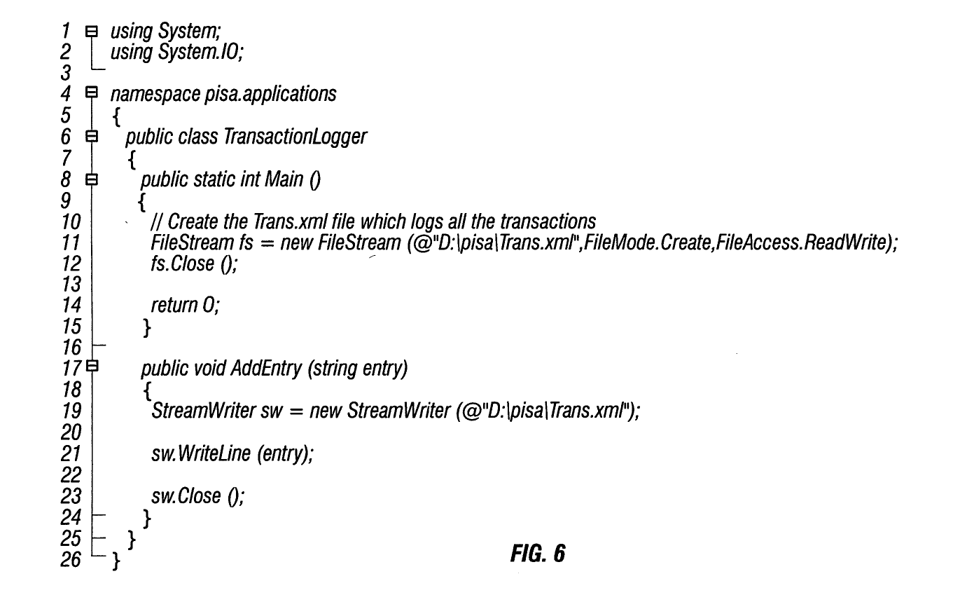

FIG. 4(a) is a timing flow diagram illustrating the method or system according to the invention to create a new data item and establishing a mechanism based on public keys s to ensure that application programs that seek access to the data item has sufficient access rights to allow the application program access to data item. FIG. 4(b) is a timing flow diagram illustrating the operation of a method or system according to the invention to verify during the run-time of the application program that the application program has sufficient access rights to allow the application program access to a particular piece of data the application program seeks to access. The operation of the methods illustrated in FIG. 4 is described here with reference to an example illustrated in FIGS. 5 through 10.

Consider an application program 301 that seeks create to a particular data item. FIG. 5 is a screen shot of a directory 501 of files stored on a smart card 101. The directory 501 includes several files, including an executable file “pisa.exe” 503 (thus, pisa.exe is a particular application program 301 as illustrated in FIGS. 3 and 4). A File Properties window 505 is displayed to show certain properties associated with the pisa.exe application program 503. One such property is the Public Key Token 507 that has been assigned to the pisa.exe application program 503 (In the examples that follow, the public key used for granting or denying access is a Public Key Token associated with data items and application programs, respectively. A Public Key Token is a compact representation of the public key. One such compact representation is an 8-byte hash of the full public key as defined in Don Box, Essential .NET, Volume I: The Common Language Runtime, Addison-Wesley, 2002, ISBN: 0201734117, Chapter 2,). In this example, the pisa.exe application program 503 has a Public Key Token 507 that has the value “E69F5695FF5A9753”.

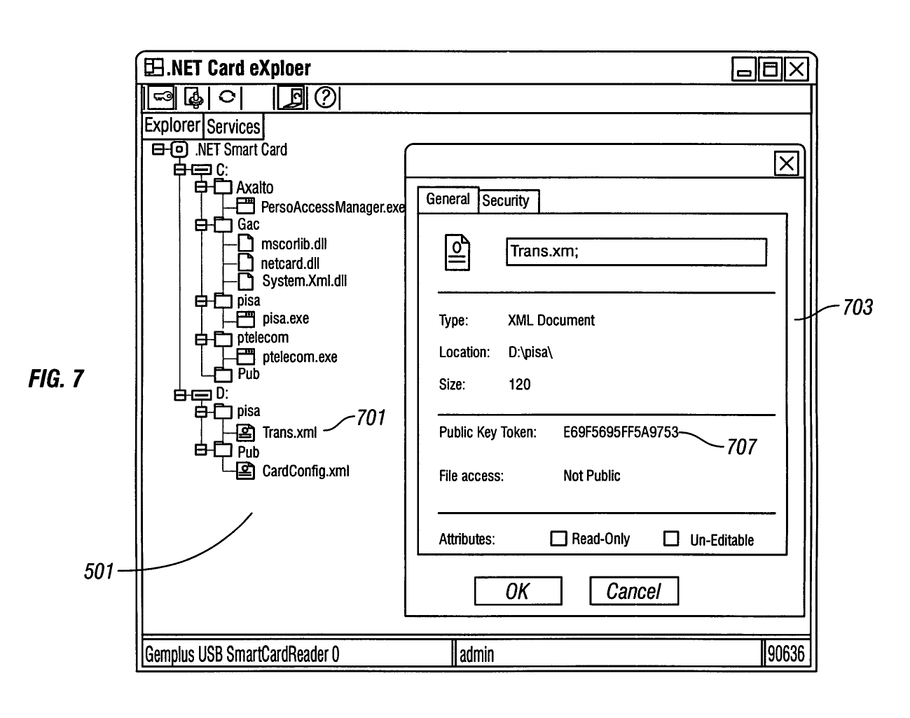

Returning now to FIG. 4(a), when an application program i 301, e.g., pisa.exe 503, seeks to create a new data item di, the application program i 301 sends a message 401 to the operating system, e.g., the interpreter 305, including an indication of which data item it wishes to create and the access rights it needs for the data item. FIG. 6 is a code segment of the pisa.exe application program 503. In line 11 the pisa.exe application program 503 seeks to create a new data item “Trans.xml” with “read-write” access.

In response to the request to create a data item di the operating system 305 adds the data item di to the directory 501 and assigns to the data item di a public key (PK_{di}) having the same value as the public key (PKᵢ) of the application program i., step 403. The operating system 305 then transmits a status message back to the application program i 305, step 405.

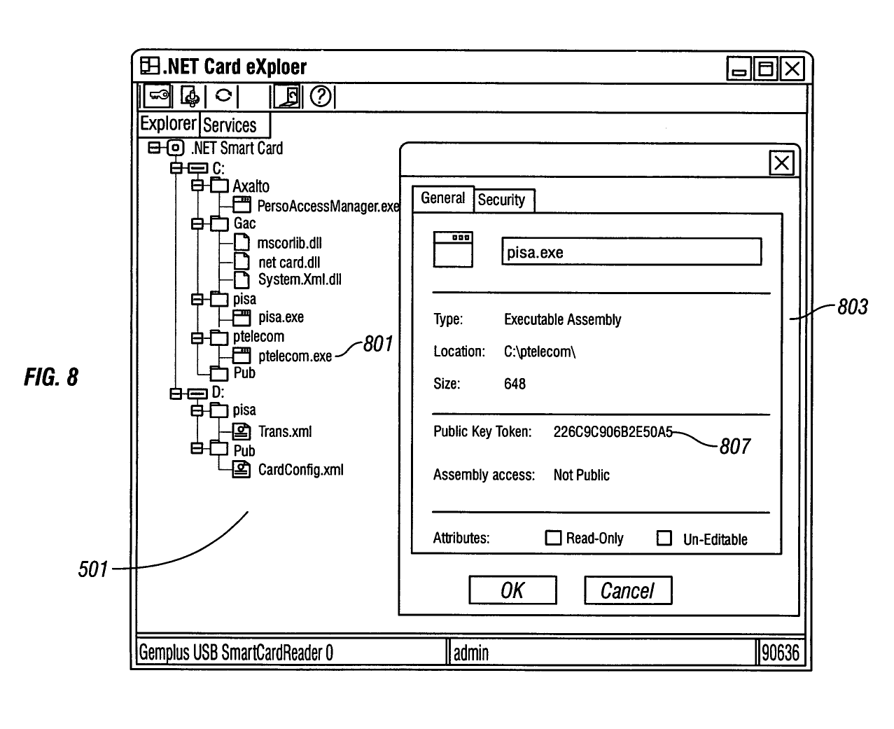

The Trans.xml data item is illustrated in FIG. 7, a further screen shot of the directory 501 shown first in FIG. 5. Now, the “Trans.xml” data item 701 has been added to the directory 501, step 403. The file properties of the Trans.xml data item 701 are illustrated in the File Properties window 703. These file properties include the Public Key Token 707 associated with the Trans.xml data item 701. Because the Trans.xml data item 701 was created by the pisa.exe application program 503, the Trans.xml data item 701 has a Public Key Token 707 with the same value as the Public Key Token 507 which belongs to the pisa.exe application program 503, namely “E69F5695FF5A9753”.

FIG. 4(b) is an illustration showing the access to an existing data item. In line 19 of FIG. 6 the pisa.exe application program 503 seeks to access the Trans.xml data item 701. A request to access the data item di is transmitted to the operating system 305, step 409. The operating system then retrieves the public key (PK_{di}) associated with the data item 411 by messaging the data item di 411, step 413. The data item di 411 sends a response message with its Public Key (PK_{di}), step 415.

In the example of FIG. 6, the Public Key Tokens of the Trans.xml data item 701 and of the pisa.exe application program 503 have the same value, namely “E69F5695FF5A9753”. Therefore, when the pisa.exe application program 503 tries to access the Trans.xml data item 701, the Trans.xml data item 701 returns the value “E69F5695FF5A9753” in its response message, step 415.

Next, the operating system 305 compares PKᵢ to PK_{di}, step 417. If these have the same value, the application program i 301 is granted access to the data item, step 419. Otherwise, an error condition has occurred and an error message may be sent back to the application program i 301, step 421.

In the example of FIG. 6, because the Public Key Tokens of the Trans.xml data item 701 and of the pisa.exe application program 503 have the same value, namely “E69F5695FF5A9753”, the comparison step 417 confirms that the pisa.exe application program 503 should be allowed access to the Trans.xlm data item 701.

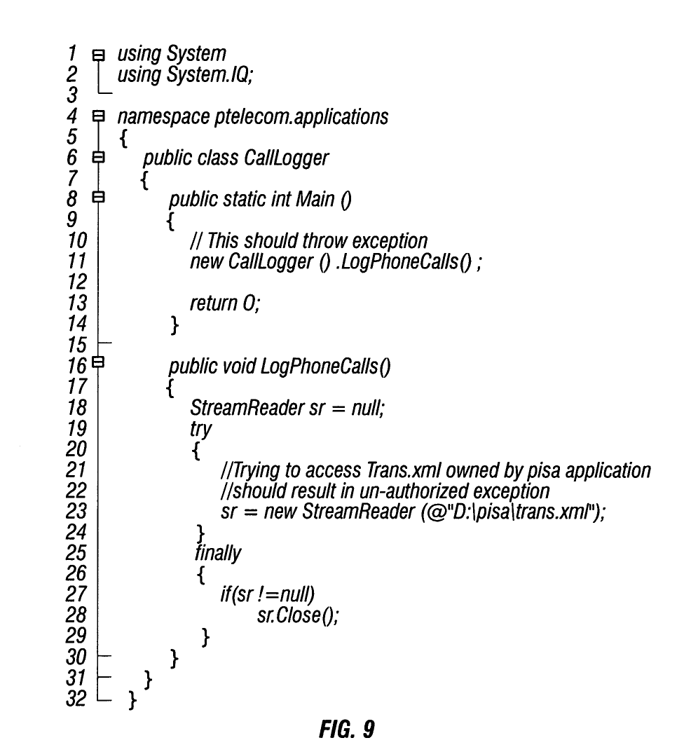

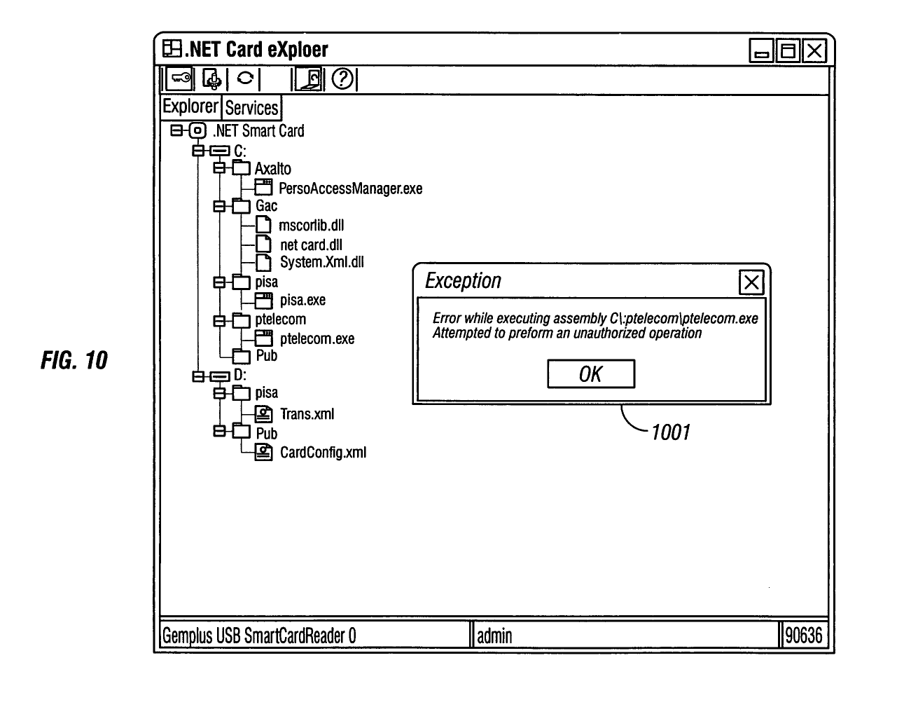

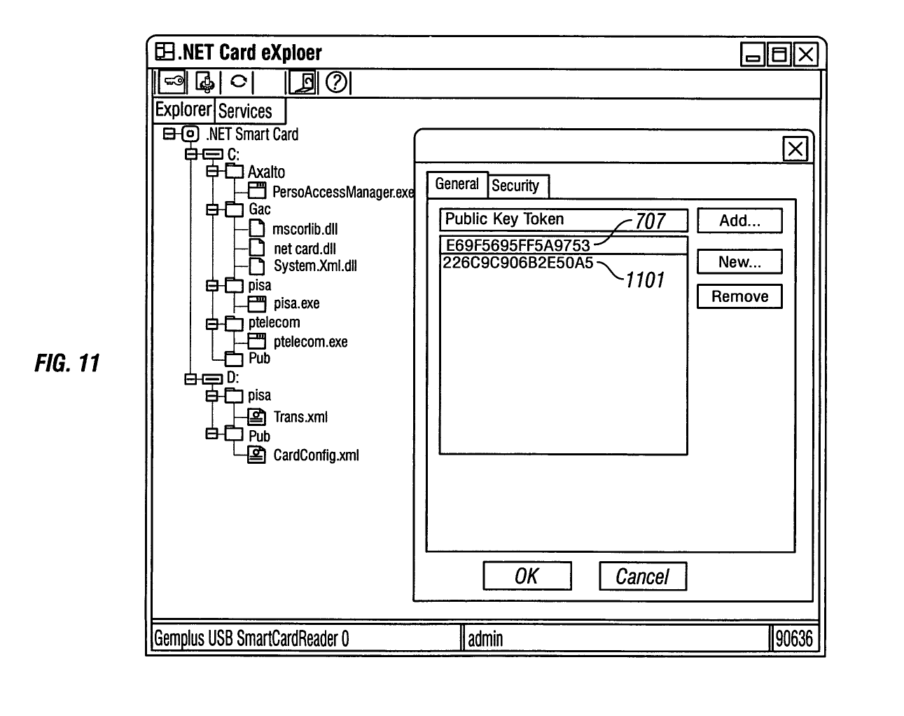

FIGS. 8, 9, and 10 illustrate an example in which an application program 301 does not have access rights to a data item it seeks access to. FIG. 8 also shows the directory 501 and a File Property window 803. In this case the File Property window 803 displays the properties of an application program ptelecom.exe 801. The Public Key Token 807 of the ptelecom.exe has a value of “226C9C906B2E50A5”. FIG. 9 is a code segment of the ptelecom.exe application program 801. In line 23 the ptelecom.exe application program 801 seeks to access the Trans.xml data item 701. In comparison step 417 (of FIG. 4(b)) the operating system 305 determines that the ptelecom.exe application program 801 does not have the same Public Key Token as the Trans.xml data item 701. Therefore, an error message is returned, step 421. An error message may also be displayed as illustrated in FIG. 10 window 1001.

The above examples have illustrated the invention using a single Public Key for each data item and application program 301. If there is a match between these Public Key s, then the application program is given access to the data item. Otherwise, an error condition is indicated. However, the limitation of a single Public Key per program and data item is merely used herein for the ease of illustration and description. In alternative embodiments data items may have multiple public keys associated therewith.

By having more than one public key associated with a data items allow multiple application programs to access data items having different public keys. Consider the example of FIG. 8, in which the ptelecom.exe application program 801 has a public key 807 with a value “226C9C906B2E50A5”. 226C9C906B2E50A5 FIG. 11 is screen shot illustrating a data file having multiple Public Key Tokens. In this example, contrary to the example of FIG. 7, the Trans.xml data item 701 has a list of Public Key Tokens that includ both the Public Key Token 707 having the value “E69F5695FF5A9753” and a Public Key Token 1101 with the value “226C9C906B2E50A5”. Given the code segment of FIG. 9, the ptelecom.exe application program 801 would be given access to the Trans.xml data item because it has a Public Key Token matching one of the Public Key Tokens of the Trans.xml data item.

In another alternative embodiment, each data item rather than having just a single Public Key associated therewith, each data item could have lists of Public Keys s associated therewith. Each list would provide a different level of access, e.g., a first list would provide read-only access to application programs with Public Keys in that list, a second list would provide read-and-write access to application programs with Public Keys in that second list, and so on for all defined levels of access including modify and delete. Furthermore, each such list may contain multiple Public Key each of which would permit an application program with that Public Key the associated level of access.

In one embodiment of the invention, the application programs are originally written in a high-level programming language, for example the C# programming language or the JAVA programming language. Programming of application programs in Java and loading such programs onto smart cards is described in U.S. Pat. No. 6,308,317, issued to Timothy J. Wilkinson, et al. on Oct. 23, 2001 and entitled Using a high level programming language with a microcontroller, the entire disclosure of which is incorporated herein by reference. The application programs are first converted from a compiled for and subsequently loaded onto the smart card 101 as CAP files.

Although specific embodiments of the invention has been described and illustrated, the invention is not to be limited to the specific forms or arrangements of parts so described and illustrated. For example, while the invention has been described in the context of smart cards, the invention is applicable to use with other resource-constrained devices. The invention is limited only by the claims.

We claim:

1. A smart card in which application programs and data items are linked in a manner that allows secure access to the data items, providing application programs the right to access a data item while preventing security breaches, allowing applications and data to be independently updated, and allowing multiple applications to share the data item, comprising:
a microprocessor;
a memory connected to the microprocessor and storing:
a file-system having a first application program having associated therewith a first public key and a data file having associated therewith a second public key, wherein the first application program comprises a data access logic operable to cause the microprocessor to attempt to access the data file;
an operator system program having an authorization logic having instructions operable to cause the microprocessor to compare the public key associated with the first application program and permitting access if the public key associated with the first application program corresponds to public key associated with the data file.

2. A smart card in which application programs and data items are linked in a manner that allows secure access to the data items, providing application programs the right to access a data item while preventing security breaches, allowing applications and data to be independently updated, and allowing multiple applications to share the data item, comprising:
a file system having at least one data item with a first public key associated therewith;
an operating system for managing the execution of application programs loaded onto the smart card and having an authorization logic for verifying that application programs have use rights allowing access to data items that such application programs seek to access wherein the authorization logic is operable to compare a public key associated with any such application program and the first public key associated with a data item the any such application program seeks to access.

3. The smart card of claim 2 wherein a first data item has associated therewith a plurality of public keys and wherein the authorization logic allows access to the first data item to an application program having a public key that corresponds to one public key in the plurality of public keys.

4. The smart card of claim 3 wherein the authorization logic allows access to the first data item to an application program having a public key that exactly matches the one public key in the plurality of public keys.

5. The smart card of claim 2 wherein the authorization logic compares the public key associated with an application program and the public key associated with the data item to determine which level of access to grant to the application program.

6. The smart card of claim 5 wherein the level of access is selected from the set including read, write, modify, delete, no access.

7. A method of operating a multi-application smart card to ensure that only application programs that have appropriate access rights to access protected data items, comprising:
associating a first public key with a protected data item;
associating a second public key with an application program;
causing a microprocessor of the multi-application program to execute the application program;
determining that the application program is seeking access to the protected data item;
in response to determining that the application program is seeking access to the protected data item, comparing the first public key to the second public key and based on that comparison determining the access right of the application program to the data item.

8. The method of claim 7 wherein the access right is selected from the set including read, write, modify, delete and no access.

9. The method of claim 8 further comprising:
in response to determining the access right to be no access, issuing an error message.

10. The method of claim 8 further comprising:
in response to detecting that the application program is attempting an operation inconsistent with the determined access right, issuing an error message.
